(19) United States
(12) Patent Application Publication
(10) Pub. No.: US 2012/0158456 A1
(43) Pub. Date: Jun. 21, 2012

(54) Forecasting Ad Traffic Based on Business Metrics in Performance-based Display Advertising

(76) Inventors: Xuerui Wang, Sunnyvale, CA (US); Ruofei (Bruce) Zhang, Mountain View, CA (US)

(21) Appl. No.: 12/973,637

(22) Filed: Dec. 20, 2010

(51) Int. Cl. G06Q 30/00

(52) U.S. Cl. 705/7.31

(57) ABSTRACT

A method, advertising network, and computer readable medium for forecasting ad traffic based on business metrics in performance-based display advertising. The method commences by defining a set of advertising campaign parameters, the advertising campaign parameters comprising target predicates, a campaign pricing model, and a campaign performance model. The method continues by forecasting a supply of impressions satisfying target predicates, based on a statistical analysis of a historical dataset containing impressions satisfying target predicates. Once a measure of forecasted supply is known, an auction model serves for calculating the likelihood of winning the forecasted impression at auction, based the campaign pricing model and the campaign performance model. Having a forecasted supply, and also an assessment of the likelihood of winning at auction, the method proceeds by determining values for various performance metrics. The performance metrics are displayed; the user makes changes to any one or more of the advertising campaign parameters.

### FIELD OF THE INVENTION

The present invention is directed towards automatic creation and management of advertising and marketing campaigns based on statistical data.

### BACKGROUND OF THE INVENTION

In display advertising systems, advertisers can buy ad space from publishers in advance by entering into booked contracts for guaranteed placement of advertisements. Or, advertisers can buy ad space on the “spot market” through an auction. Although the quality of inventory (page views) for booked contracts is often qualitatively better than the quality of inventory on the spot market, the spot marketplace is nevertheless important for advertisers to maximize their return on investment. During progression of an advertising campaign, and due to the uncertainty of availability of inventory in the spot market, advertisers can use the spot market to reach their intended audience at rates that are often lower than rates for booked contracts for guaranteed placement of advertisements.

Forecasting ad traffic is useful in planning budgeting and fine-tuning characteristics of display advertising campaigns. One way to forecast traffic is to forecast impressions based on history, and this technique is useful in campaigns with guaranteed placement of advertisements. Yet, for accurate forecasting of impressions in the spot market, it is not only the history of inventory of impressions (i.e. potential inventory), but also the history of winning in an auction (i.e. winnable inventory) for those impressions that ultimately determines the accuracy of a forecast. Moreover, accuracy (or lack of accuracy) in forecasting can determine the ultimate success or failure of a campaign to achieve quantifiable performance objectives.

Indeed, when advertisers enter into contracts with quantifiable performance objectives (e.g. ROI, impressions per spend, etc), it is natural for the advertisers to require a forecast of how many impressions, and/or click-throughs, and/or or click-action-conversions, can be delivered or won, given a particular targeting attribute list (or bidded keyword list) and a given bid amount. However, using only legacy techniques, producing such ad traffic forecasts, even within large margins of error, is quite challenging. In particular, challenges arise since:
(1) The inventory supply varies over time, and the variations depend heavily on the contract fulfillment of guaranteed delivery contracts;
(2) Online ad selection in the spot market is a complicated process based on hundreds of features and targeting attributes, all of which need to be considered within a dynamic and competitive bid landscape;
(3) The scale of the problem is daunting, involving billions of impressions; and
(4) New contracts from existing or new advertisers are booked on a daily basis, creating a dynamic environment for matching spot market supply to demand, and a dynamic environment for forecasting future supply (sometimes with little or no history from which to base a forecast).

Thus, a method for forecasting inventories for use in tuning business metrics in the context of performance-based display advertising is needed.

Other automated features and advantages of the present invention will be apparent from the accompanying drawings, and from the detailed description that follows below.

### SUMMARY OF THE INVENTION

A method, advertising network, and computer readable medium for forecasting ad traffic based on business metrics in performance-based display advertising. The method commences by defining a set of advertising campaign parameters, the advertising campaign parameters comprising target predicates, a campaign pricing model, and a campaign performance model. The method continues by forecasting a supply of impressions satisfying target predicates, based on a statistical analysis of a historical dataset containing impressions satisfying target predicates. Once a measure of forecasted supply is known, an auction model serves for calculating the likelihood of winning the forecasted impression at auction, based the campaign pricing model and the campaign performance model. Having a forecasted supply, and also an assessment of the likelihood of winning at auction, the method proceeds by determining values for various performance metrics. The performance metrics are displayed; the user makes changes to any one or more of the advertising campaign parameters.

### BRIEF DESCRIPTION OF THE DRAWINGS

The novel features of the invention are set forth in the appended claims. However, for purpose of explanation, several embodiments of the invention are set forth in the following figures.

FIG. 1A shows an ad network environment in which some embodiments operate.

FIG. 1B shows an ad network environment including an additional content server in which some embodiments operate.

FIG. 1C shows a screen device with a multi-step procedure for creating a campaign, according to one embodiment.

FIG. 1D shows a screen device for a campaign set-up procedure in an advertising campaign, according to an exemplary embodiment.

FIG. 1E depicts a screen device for use by a campaign management module, according to an exemplary embodiment.

FIG. 1F shows a screen device for a campaign set-up procedure for defining advertising spending parameters for an advertising campaign, according to an exemplary embodiment.

FIG. 1G shows a screen device for ongoing campaign management using a dashboard showing settings and statistics for an advertising campaign, according to an exemplary embodiment

FIG. 2 is a flowchart of a method for establishing business metrics within a system for forecasting ad traffic based on business metrics in performance-based display advertising.

FIG. 3 shows an ad network environment including a campaign management module in which some embodiments operate.

FIG. 4 is a data flow diagram of a system for forecasting ad traffic based on business metrics in performance-based display advertising in which some embodiments operate.

FIG. 5 is a data flow diagram of a system for supply forecasting based on business metrics in performance-based display advertising in which some embodiments operate.

FIG. 6 is a data flow diagram of a system for modeling an advertisement auction based on business metrics in performance-based display advertising in which some embodiments operate.

FIG. 7 is a data flow diagram of a system for campaign-specific click-response rate predictor based on business metrics in performance-based display advertising in which some embodiments operate.

FIG. 8 depicts a block diagram of a system to perform certain functions of an advertising server network, in accordance with one embodiment of the invention.

FIG. 9 is a diagrammatic representation of a network including nodes for client computer systems, nodes for server computer systems, and nodes for network infrastructure, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

The following description is organized into four sections:
Section I: General Terms and Network Environment
Section II: Creation and Presentation of an Advertising Campaign
Section III: Systems and Methods of Exemplary Embodiments
Section IV: Integration with Campaign Pricing and Performance Models

### Section I: General Terms and Network Environment

Some of the terms used in this description are defined below (in alphabetical order) for easy reference. These terms are not rigidly restricted to these definitions. A term may be further defined by the term's use in other sections of this description.

“Ad” (e.g. ad, item and/or message) means a paid announcement, as of goods or services for sale, preferably on a network such as the internet. An ad may also be referred to as an item and/or a message.

“Ad call” means a message sent by a computer to an ad server for requesting an ad to be displayed.

“Ad click-through rate” (e.g. click-through rate) means a measurement of ad clicks per a period of time.

“Ad code” means the HTML or other markup language description that describes an advertisement or message in such a manner as can be parsed by a browser. Ad code may include references to other ad code. Ad code may mean any subset, or portion or segment of ad code that describes an advertisement or message in such a manner as can be parsed by a browser.

“Ad server” is a server that is configured for serving one or more ads to user devices. An ad server is preferably controlled by a publisher of a website and/or an advertiser of online ads. A server is defined below.

“Advertiser” (e.g. messenger and/or messaging customer, etc) means an entity that is in the business of marketing a product and/or a service to users. An advertiser may include, without limitation, a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a website.

“Application server” is a server that is configured for running one or more devices loaded on the application server. For example, an application server may run a device configured for deducing shadow profiles.

“Click” (e.g. ad click) means a selection of an ad impression by using a selection device such as, for example, a computer mouse or a touch-sensitive display.

“Client” means the client part of a client-server architecture. A client is typically a user device and/or an application that runs on a user device. A client typically relies on a server to perform some operations. For example, an email client is an application that enables a user to send and receive email via an email server. In this example, the computer running such an email client may also be referred to as a client.

“Conversion” (e.g. ad conversion) means a purchase of a product/service that happens as a result of a user responding to an ad and/or a coupon.

“Coupon” (e.g. coupon ad) means a portion of a certificate, ticket, label, ad or the like—set off from the main body by dotted lines or the like to emphasize its separability—entitling the holder to something, such as a gift or discount, or for use as an order blank or a contest entry form, etc. A coupon is designed in a convenient format for a user to “take” the coupon to a seller to receive an advertised benefit.

“Database” (e.g. database system, etc) means a collection of data organized in such a way that a computer program may quickly select desired pieces of the data. A database is an electronic filing system. In some instances, the term “database” is used as shorthand for a “database management system”. A database may be implemented as any type of data storage structure capable of providing for the retrieval and storage of a variety of data types. For instance, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” means hardware, software or a combination thereof. A device may sometimes be referred to as an apparatus. Examples of a device include, without limitation, a software application such as Microsoft Word™ or a database; or hardware such as a laptop computer, a server, a display; or a computer mouse and/or a hard disk.

“Impression” (e.g. ad impression) means a delivery of an ad to a user device for viewing by a user.

“Item” means an ad, which is defined above.

“Marketplace” means a world of commercial activity where products and/or services are browsed, bought and/or sold, etc. A marketplace may be located over a network, such as the internet. A marketplace may also be located in a physical environment, such as a shopping mall.

“Message” means an ad, which is defined above.

“Messaging” means advertising, which is defined above.

“Messenger” means an advertiser, which is defined above.

“Network” means a connection, between any two or more computers, that permits the transmission of data. A network may be any combination of networks including, without limitation, the internet, a local area network, a wide area network, a wireless network, and/or a cellular network.

“Publisher” means an entity that publishes, on a network, a web page having content and/or ads, etc.

“Server” means a software application that provides services to other computer programs (and their users) on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload.

“Social network” or “social networking website” means a networked software application having user accounts (e.g. nodes) that are coupled by using one or more interdependencies such as, for example, friendship, kinship, common interest, financial exchange, dislike, sexual relationship, beliefs, knowledge and/or prestige. Examples of a social network include, without limitation, Facebook™, Twitter™, Myspace™, Delicious™, Digg™, and/or Stumble Upon™

“Software” means a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” means a device or multiple coupled devices. A device is defined above.

“User” (e.g. consumer, etc) means an operator of a user device. A user is typically a person who seeks to acquire a product and/or service. For example, a user may be a woman who is browsing Yahoo!™ Shopping for a new cell phone to replace her current cell phone. The term “user” may also refer to a user device, depending on the context.

“User device” (e.g. computer, user computer, client and/or server, etc) means a single computer or a network of interacting computers. A user device is a computer that a user may use to communicate with other devices over a network, such as the internet. A user device is a combination of a hardware system, a software operating system, and perhaps one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and/or a Sun Microsystems™ workstation having a UNIX operating system.

“Web browser” means a software program that may display text or graphics or both, from web pages on websites. Examples of a web browser include, without limitation, Mozilla Firefox™ and Microsoft Internet Explorer™

“Web page” means documents written in a mark-up language including, without limitation, HTML (hypertext mark-up language), VRML (virtual reality modeling language), dynamic HTML, XML (extensible mark-up language), and/or other related computer languages. A web page may also refer to a collection of such documents reachable through one specific internet address and/or through one specific website. A web page may also refer to any document obtainable through a particular URL (uniform resource locator).

“Web portal” (e.g. public portal) means a website or service that offers a broad array of resources and services such as, for example, email, forums, search engines, and online shopping malls. The first web portals were online services, such as AOL, that provided access to the web. However, now, most of the traditional search engines (e.g. Yahoo!™) have transformed themselves into web portals to attract and keep a larger audience.

“Web server” is a server configured for serving at least one web page to a web browser. An example of a web server is a Yahoo!™ web server. A server is defined above.

“Website” means one or more web pages. A website preferably includes a plurality of web pages virtually connected by links or URL addresses to form a coherent group.

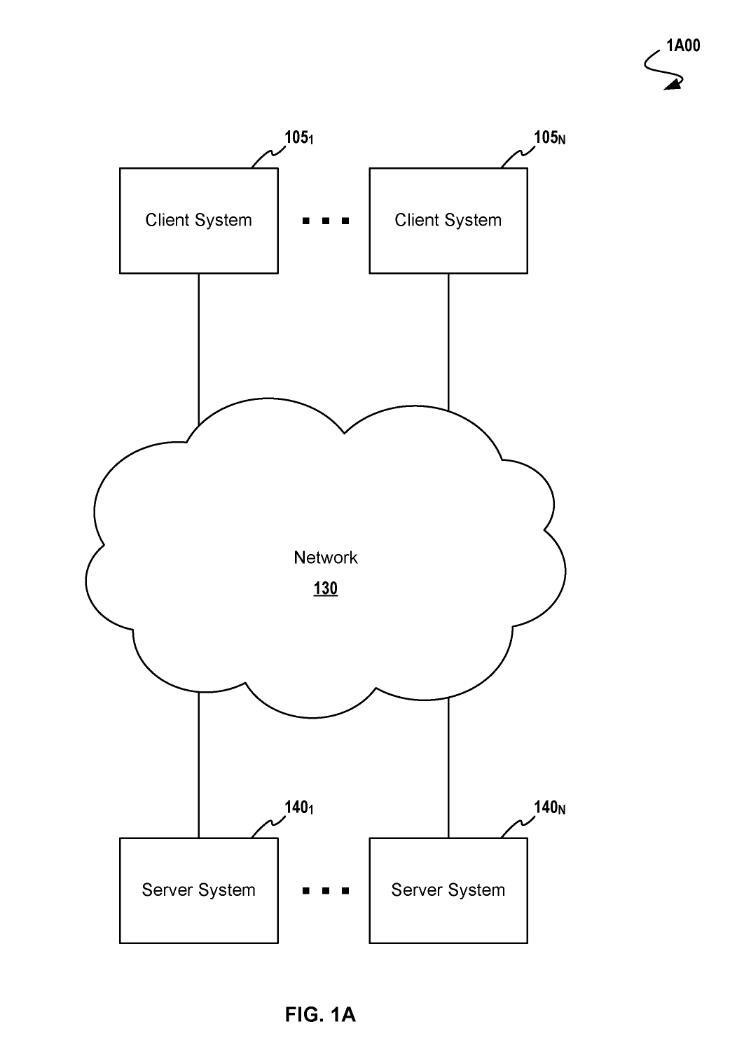

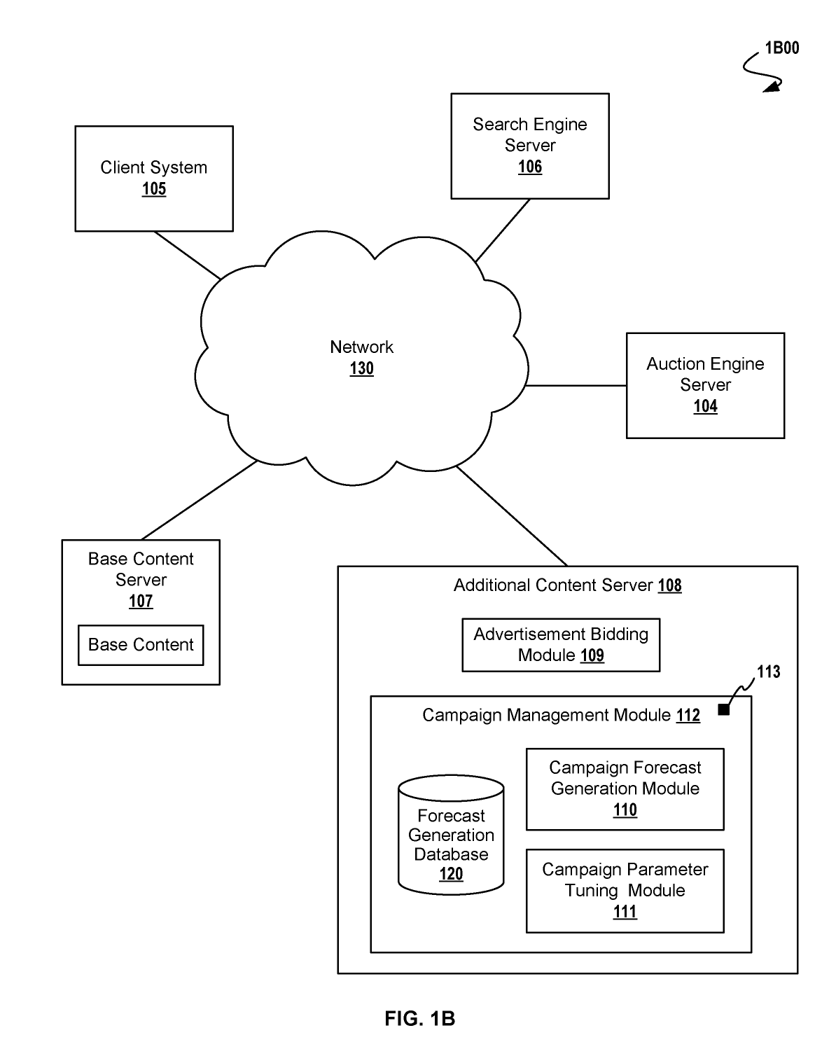

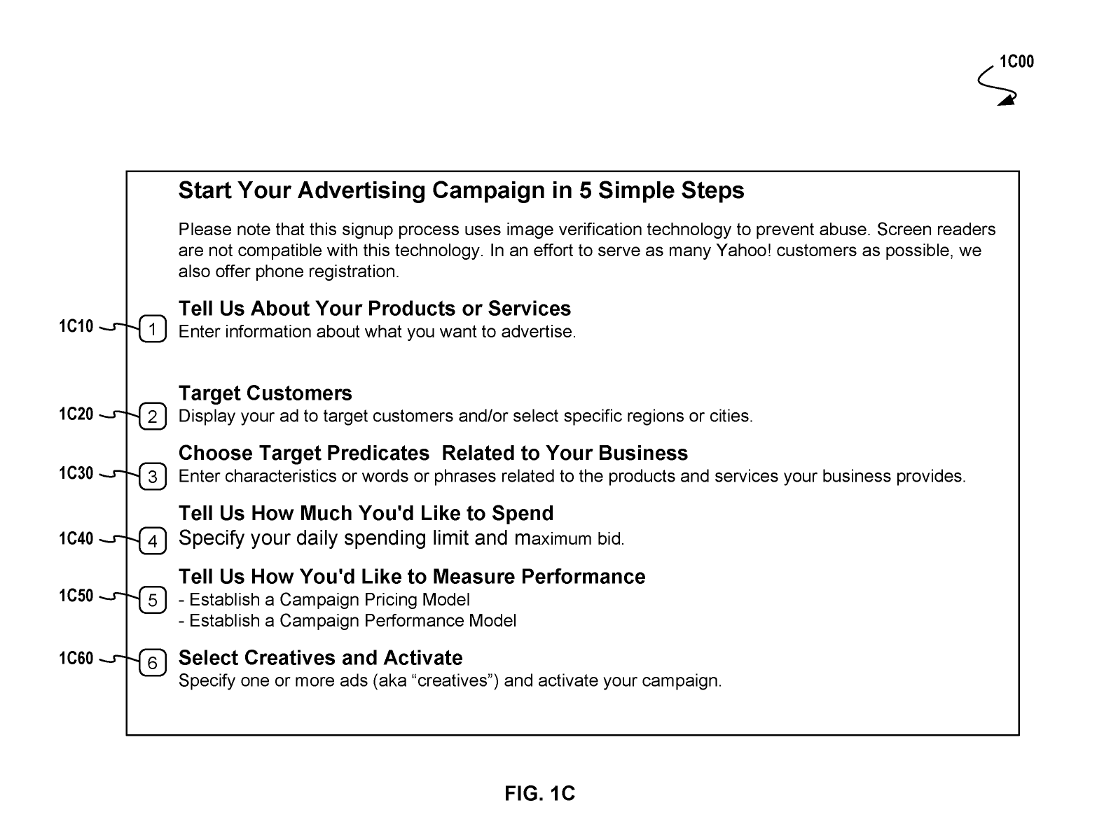

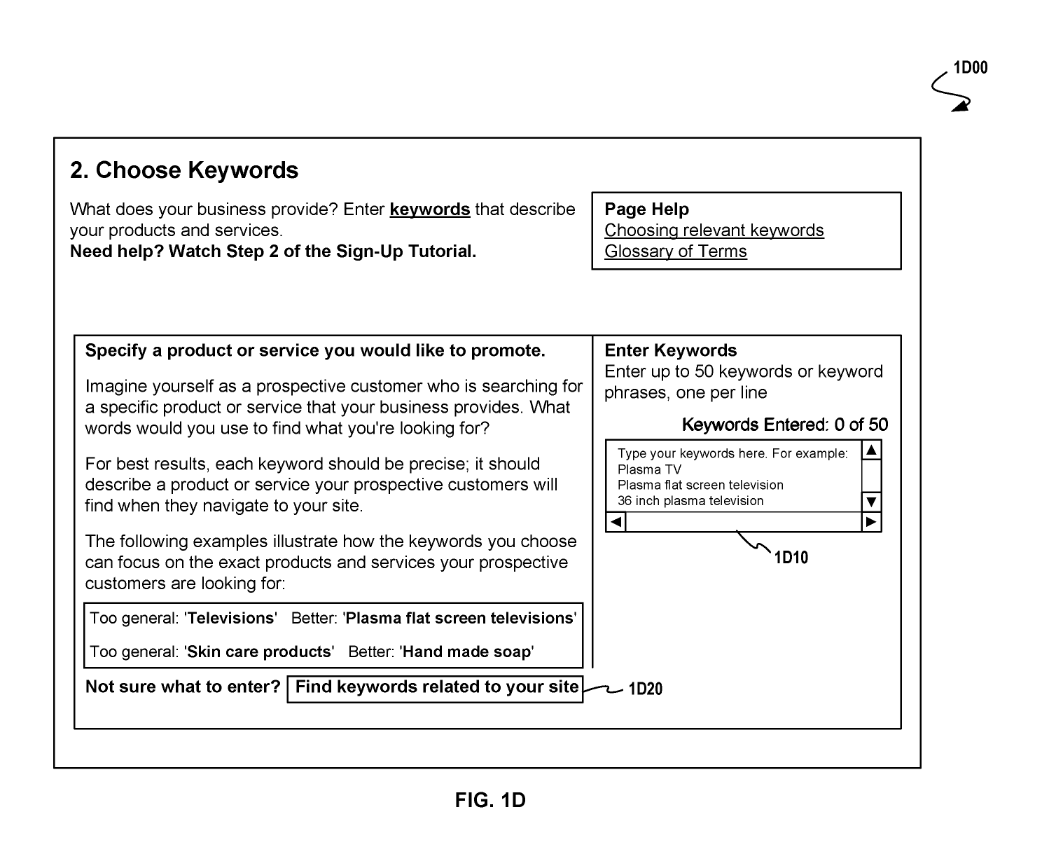

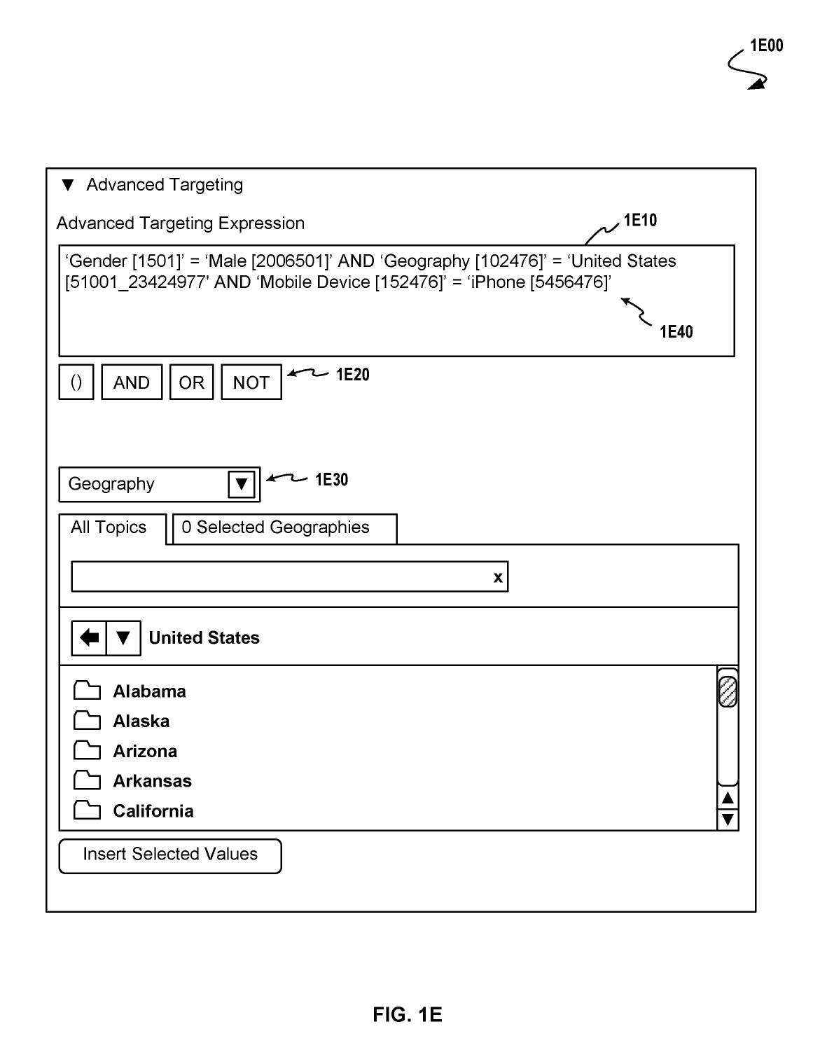

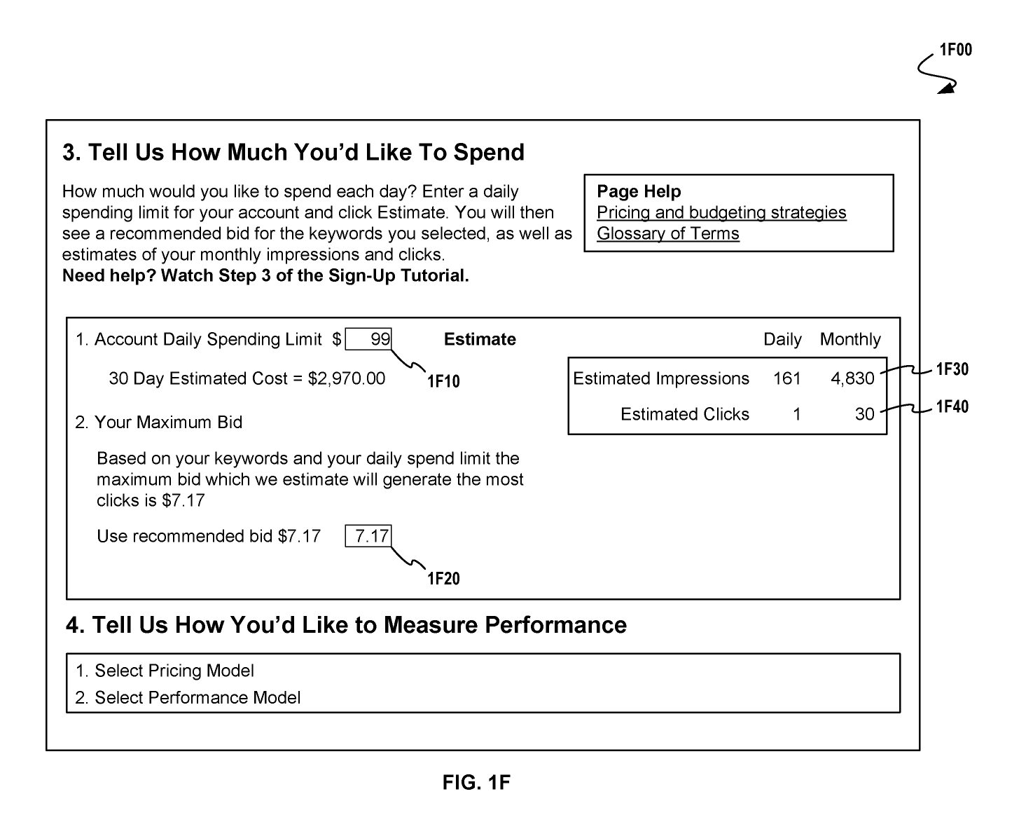

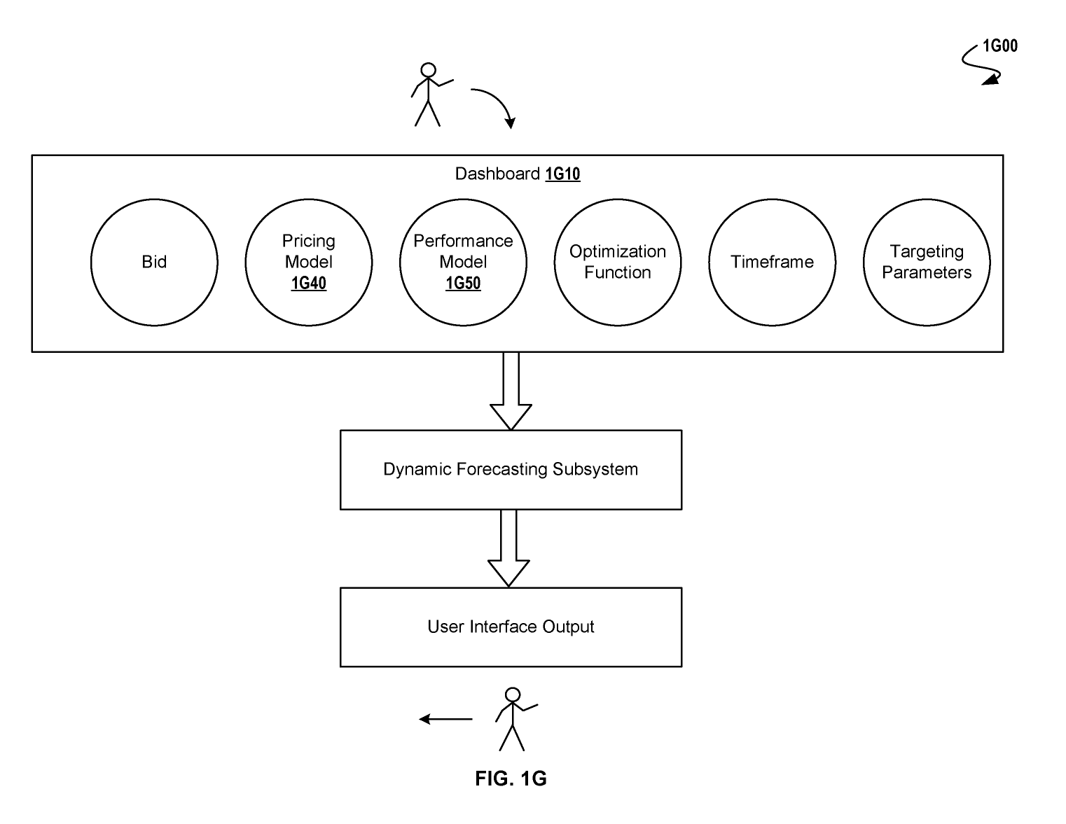

FIG. 1A shows an ad network environment in which some embodiments operate. As shown, the network environment 1A00 includes client systems 105₁ to 105_{N} and server systems 140₁ to 140_{N}, each coupled to a network 130 (such as the Internet or an intranet, an extranet, a virtual private network, a non-TCP/IP-based network, any LAN or WAN, or the like). In some embodiments, the client systems 105₁ to 105_{N} and/or server systems 140₁ to 140_{N} are configured to perform the methods described herein. The methods of some embodiments may be implemented in software or in hardware, or using both software and hardware. In some embodiments, a system 1A00 is configured to optimize a campaign and present the optimized selection of campaign-related variables to be displayed to a user. As used herein, the term server applies to any of the aforementioned server systems, 140₁ to 140_{N}, or the term server might more generally refer to any computing platform, possibly including any one or more client systems 105₁ to 105_{N}.

A server system 140₁ may include a single server computer or a plurality of server systems 140₁ to 140_{N} for providing a variety of network services (e.g. presenting advertisements, presenting an advertising campaign dashboard, performing search queries, providing base content, capturing and filtering web page information and/or user activity data, etc). In various embodiments, each client system 105 is configured to communicate with a server system 140. The client system 105 may be implemented in the form of a desktop personal computer, a workstation, a laptop computer, a PDA, a cell phone, any wireless application protocol (WAP) enabled device, or any other device capable of communicating directly or indirectly with a network. The client system 105 typically runs a web browsing program (such as Microsoft's Internet Explorer™ browser, Netscape's Navigator™ browser, the Mozilla™ browser, the Opera™ browser, a WAP-enabled browser in the case of a cell phone, a PDA or other wireless device, or the like) allowing the user of a client system 105 to interact through the network 80 and receive content from server systems 140₁ to 140_{N}. The client system 105 typically includes one or more user interface devices (such as a keyboard, a mouse, a roller ball, a touch screen, a pen or the like) for interacting with a graphical user interface (GUI) of the web browser on a display (e.g. a monitor screen, an LCD display, etc).

FIG. 1B shows an ad network environment including an additional content server 108 in which some embodiments operate. The advertising system 1B00 may include zero or more client systems 105, zero or more base content servers (e.g. publishers) 107, zero or more additional content servers 108, and/or zero or more search engine servers 106, each connected to a network 130 (e.g. Internet, intranet, subnet, etc). The advertising system 1B00 might be further configured to select additional content (e.g. advertisements) to be sent to a user/client system, possibly together with related base content (e.g. base content for an auto dealership might include additional content in the form of an advertisement for a featured automobile).

More specifically, the client system 105 is configured to request and receive content (e.g. in the form of web pages) from a base content server 107 and/or additional content servers 108, where such content may include base content (a requested web page) and/or additional content (advertisements, an advertising campaign control panel, a dashboard, a keyword input screen device, etc). In some embodiments, the client system 105 (operated by a user or a bot) may retrieve an initial web page (termed here as the referring web page) that can be rendered into one or more objects (e.g. images, text, hypertext links, etc), where at least one such object contains one or more hyperlinks to one or more landing web pages. Upon selection of one of the hyperlinks (referred to as the primary hyperlink) by the user, the client system sends a request (e.g. HTTP request) to the base content server 107 that stores and maintains the selected landing web page (the primary web page) of the selected hyperlink.

The client system 105 may be further configured to accept search queries and receive search results from the search engine server 106. In some embodiments, the client system 105 may display an initial query entry web page where a user inputs (e.g. via a user interface) a search query (comprising one or more search query terms). The client system 105 then receives (from the search engine server 106) and displays a search results web page. The search results web page shows search results comprising one or more hyperlinks to one or more landing web pages. The client system 105 may also be configured to receive a primary web page and additional content (advertisements) related to the primary web page. The client system 105 may be further configured to display the received base content and/or additional content and receive selections of advertisements from the user (e.g. through a user interface). Of course, certain user activity might be captured either by the client system 105, or by the base content server 107, or by the additional content server 108, or by the search engine server 106, and/or any combination of these. The captured user activity (in whole or in part) can be retrieved by any of the aforementioned systems or servers, and might be used in various trend analyses, or statistical analyses or other analyses, and such analyses might be used by the additional content server 108 when performing statistical modeling of ad traffic and events.

In still other embodiments, the search engine server 106 is configured to receive a search query from the client system 105, perform the search query (comprising one or more terms), attach the search query terms to a search results web page (for example, within the uniform resource locator address), and serve the search results web page to the client system 105, the search results web page typically including search results in the form of one or more hyperlinks to one or more landing web pages. Of course, in large-scale systems similar to the system 1B00 (e.g. the Internet, millions of subscribing terminals, and millions of base content publishers), various behaviors (e.g. web page traversals, clicks, other actions) might be monitored (e.g. by servers 106, 107, 108, or any other server), and thereby certain statistics describing aggregate user behavior can be amassed and stored for subsequent retrieval. Of course, in addition to aggregate user behavior, individual user behaviors (e.g. web page traversals, clicks, other actions) can be measured after an impression and such individual user behaviors can be correlated to the impression.

In some embodiments, an advertisement is associated with one or more target predicates that represent or describe the user (audience) sought by the advertiser. In still other embodiments, an advertisement is structured so as to be dynamically configured based on one or more target predicates. The additional content server 108 comprises an advertisement bidding module 109 which, in cooperation with an auction engine server 104 is used to determine which advertisements (if any) from the additional content server 108 to serve to the user/client system requesting the primary web page.

As used herein, a target predicate can be any form of an expression, possibly a Boolean expression, that seeks to represent one or more characteristics of a user, or that seeks to represent one or more characteristics of a search operation (e.g. keywords). For example, “(GENDER=male && AGE=45)” is one possible representation of a target predicate.

In some embodiments, an advertisement is associated with one or more search queries and/or one or more keywords that represent and describe the advertisement. In other embodiments, an advertisement is associated with one or more bid phrases, a bid phrase comprising one or more search query or keyword terms.

As used herein, a bid phrase can comprise a single term (e.g. “cars,” “television,” etc) or a plurality of terms (e.g. “car dealer,” “New York City,” etc). For example, the set of primary web page keywords may comprise “automobile,” “sports car,” “sports car accessories,” etc. A particular advertisement may be represented by the bid phrase “sports car,” “high performance automobile,” etc. As such, this particular bid phrase may be selected for bidding in an auction, possibly involving one or more auction engine servers 104.

The additional content server 108 may be part of a network service provider (such as Yahoo! and its associated properties) that provide users an entrance and guide into the resources of the Internet. The network service provider may operate one or more search engine servers 106, one or more base content servers 107, one or more additional content servers 108, and/or one or more auction engine servers 104 to provide a range of search, email, news, shopping, and other content and services. In other embodiments, the base content server 107, the additional content server 108, the search engine server 106, and any auction engine servers 104 may be operated by separate entities.

As just mentioned, a network service provider may operate one or more additional content servers 108, and/or one or more auction engine servers 104, and such servers might be coordinated to serve advertisements—possibly selected on the basis of a guaranteed contract, or on the basis of the advertiser winning a spot in an auction. Of course, to facilitate the selection and auction process, it might be convenient for a sponsor (e.g. an advertiser) to establish a database of advertisements, possibly including bid phrases and other parameters use in the management of the how, when, where, and under what circumstances an advertisement is shown. Such a collection of parameters is termed an advertising campaign, and the parameters involved in the definition and execution of a campaign are termed advertising campaign parameters. In exemplary embodiments, an additional content server might contain a campaign management module 112 that is configured to manually, or semi-automatically, or fully-automatically populate an advertising campaign with a collection of advertising campaign parameters 113. As shown, the campaign management module 112 includes a campaign forecast generation module 110 and a campaign parameter tuning module 111. Further, a campaign forecast generation module 110 and a campaign parameter tuning module 111 can each communicate with a forecast generation database 120 (e.g. a historical dataset or other datasets, discussed below).

Forecasting, and providing campaign parameter tuning information to an advertiser according to the embodiments disclosed herein allows any advertiser to receive and use better intelligence so that advertising campaigns can be much better planned and executed (especially given an accurate forecast of future inventory available).

Embodiments described herein include a generalized framework for forecasting ad traffic (impressions, click-through, and click-conversions) in a spot market marketplace. Some abstract forecasting techniques provide forecasts that depend on analysis of a time series of the historical performance of ad campaigns, yet when an ad campaign changes its bid or targeting attributes, or when an ad campaign has little or no history, such techniques can lose accuracy. Such abstract forecasting techniques (e.g. abstracting at the ad campaign level of abstraction) may ignore too much detail in the process of the abstraction, and may be prone to accuracy fluctuations as aspects of the campaign change. One alternative to the aforementioned (overbroad) abstract forecasting is to try to mimic the dynamics of the online advertising system in minute detail. The embodiments disclosed herein operate at a medium-level of abstraction, without having to model minute details of the competitive landscape.

The campaign management module 112 seeks to automatically generate and manage aspects of an advertising campaign. For example, the campaign forecast generation module 110 serves to generate ad traffic forecasts based on the abstraction described in the foregoing paragraphs. Additionally, the campaign parameter tuning module 111 serves to automatically (or in a computer-aided manner) aid the advertiser in selecting and changing advertising campaign parameters, in particular business metrics and performance metrics. Strictly as an example, a business or performance metric can be a quantity expressed as a unitless number (e.g. return on investment, number of impressions seen by a specific target audience, percent of spend to date, etc), or a business or performance metric can be a quantity expressed in specific units (e.g. cost in dollars, value in dollars, dollars per day, etc).

### Section II: Creation and Presentation of an Advertising Campaign

FIG. 1C shows a screen device 1C00 with a multi-step procedure for creating a campaign, according to one embodiment. As shown, the steps for creating a campaign might include providing some initial information about the products or services to be advertised (see step 1C10), establishing geographic coverage (see step 1C20), defining keywords and bid phrases 1C30, defining advertising spend and budget-oriented parameters (see step 1C40), defining metrics for measuring performance of the campaign (see step 1C50), and specifying creatives for the campaign (see step 1C60). In various embodiments, one or more of the steps 1C10-1C60 might be performed on the basis of user interaction from a client system 105. In other embodiments one or more of the steps 1C10-1C60 might be performed either fully automatically, or in a computer-aided manner by the additional content server 108.

Now, considering a process for defining metrics for measuring performance of the campaign (e.g. using step 1C50), when advertisers define campaigns with performance objectives in mind, it is natural for them to have an idea of how they want to measure the performance of a campaign. In some cases, an advertiser might measure performance solely on the basis of how many impressions are merely seen by a specific target audience (e.g. in the case of a branding campaign). In other cases, an advertiser might want to measure performance based on the number of clicks received on an advertisement within the campaign (e.g. using a click on an ad metric), In still other cases, an advertiser might want to measure performance based on the number of actions taken by a targeted user in response to an advertisement within the campaign (e.g. using an action taken metric). Within the context of performance-based display advertising, several campaign performance models, and corresponding campaign pricing models emerge. Table 1 shows exemplary campaign pricing models, and Table 2 shows exemplary campaign performance models.

TABLE 1

| Campaign | | |
|---|---|---|
| Pricing Model | Campaign Pricing | Measurement(s) included in |
| Name | Model Acronym | Metric |
| Cost-per- | CPM | Tally impressions of an ad (e.g. the ad was |
| Thousand | | displayed on a web page) and multiply by the |
| Impressions | | CPM cost. |
| Cost-per-Click | CPC | Tally clicks on an ad (e.g. the ad was clicked by |
| | | a user after being displayed on a web page) and |
| | | multiply by the CPC cost. |
| Cost-per-Action | CPA | Tally completion of a specific action (e.g. a |
| | | survey was completed by a user after a |
| | | corresponding ad was displayed on a web page) |
| | | and multiply by the CPA cost. |
| Dynamic CPM | dCPM | Multiply occurrences of an impression of an ad |
| | | (e.g. the ad was displayed on a web page) by |
| | | the bid needed to win at auction. |
| Dynamic CPM | dCPM_SpendMax | Multiply occurrences of an impression of an ad |
| subject to | | (e.g. the ad was displayed on a web page) by |
| maximum bid | | the bid needed to win at auction (subject to |
| constraint | | maximum bid). |
| Dynamic CPM | dCPM_WinAtAllCost | Multiply occurrences of an impression of an ad |
| subject to | | (e.g. the ad was displayed on a web page) by |
| maximum daily | | the bid needed to win at auction (subject to |
| spend constraint | | maximum daily spending limit of the campaign). |

TABLE 2

| Campaign Performance | Campaign Performance | |
|---|---|---|
| Model Name | Model Acronym | Performance Goal |
| Minimize Cost-per-Click | Min_CPC | Minimize Cost- |
| | | per-Click |
| Minimize Cost-per-Action | Min_CPA | Minimize Cost- |
| | | per-Action |
| Bid Cost | Bid_Cost | Minimize Bid Cost |

It can now be understood that forecasting supply, and forecasting metrics related to a forecasted supply (e.g. forecasting the number of impressions expected to be won in auction), can depend on the advertiser's selected campaign pricing model. The advertiser may also desire to know how many impressions, click-throughs or click conversions can be delivered for a particular targeting attribute list and a given bid in order to do more effective budget planning. If the advertiser is an existing customer, then it may be possible to manually estimate how many click-throughs or click conversions to expect assuming that the media price or campaign performance goals remain the same. However, if the advertiser wants guidance or recommendations on what they should expect in the event they are willing to change their media price or performance goals (such as the CPA), this is a much more difficult problem—even if there is ample historical data to draw from.

Embodiments described herein allow an advertiser (or his agent) to get better intelligence so that media buys can be much better planned and executed against inventory available. Advertisers might have “in-house” tools and manual processes designed to track and forecast these activities based on existing campaigns and media prices, however it is extremely difficult to provide automated guidance on what can be delivered should the media price be increased or decreased. It becomes even more difficult when a new ad campaign is created, since there may be no historical data available tracking its performance.

In some cases, an advertiser is sufficiently sophisticated with respect to budget setting (e.g. the advertiser has some reasonable expectations as regards to needed aggregate number of clicks, projected cost of clicks, monthly budget, etc), but is unable to forecast impressions and ad traffic in order to optimize the campaign to maximize business metrics (e.g. projected return on investment).

FIG. 1D shows a screen device 1D00 for a campaign set-up procedure in an advertising campaign, according to an exemplary embodiment. As shown, a field, namely field 1D10 (or other screen device), might be populated manually via user input, or it might be populated either fully automatically, or in a computer-aided manner by the additional content server 108 possibly in conjunction with a campaign management module 112. It should be emphasized that any manually entered information might be used in conjunction with a campaign management module 112. In fact, heuristics followed by operations in a campaign management module 112 might employ user-specified information to drive assessment of a user-specified product or service web page, or possibly to ratify or score candidate extractions from such a user-specified product or service web page. In some embodiments, candidate keywords or combinations of keywords or bid phrases, or even target predicates (see FIG. 1E) might be retrieved or inferred from a prospective advertiser's product or service web pages, and then auto-populated into the field 1D10 (or into some underlying database).

As shown, a screen device 1D00 might provide tips, hints, page help and/or other resources to aid the user in completing (e.g. in cases of manually entered information) or in accepting (e.g. in cases of computer-aided information population) any auto-populated information. Further, some embodiments might provide one or more screen devices to aid an advertiser. As shown, the button “Find keywords related to your site” 1D20 might be presented to an advertiser, and clicking the button might invoke one or more operations within a campaign management module 112.

FIG. 1E depicts a screen device 1E00 for use by a campaign management module 112, according to an exemplary embodiment. As shown, a target predicate 1E40 can be defined using a text entry box 1E10, possibly in conjunction with predicate logical operator buttons 1E20 in order to construct an advanced target predicate expression. The screen device 1E00 may include a pulldown menu 1E30 from which values in the pulldown are populated. As shown screen device 1E00 includes an exemplary pulldown menu 1E30 for selecting a geography, which example is illustrative, and not intended to be limiting.

FIG. 1F shows a screen device 1F00 for a campaign set-up procedure for defining advertising spending parameters for an advertising campaign, according to an exemplary embodiment. As shown, one or more fields, namely fields 1F10 and 1F20, might be populated manually via a text field or other screen device, or it might be populated either fully automatically, or in a computer-aided manner as populated by the additional content server 108. Similarly, one or more fields, namely fields in lines 1F30 and 1F40, might be presented to a user via a text field or other screen device, and might be populated either fully automatically, or in a computer-aided manner as populated by the additional content server 108, or fields in lines 1F30-1F40 might be calculated by the additional content server 108, and possibly used in further calculations, possibly without ever being presented to the user. Given a campaign variables (e.g. maximum bid limit, daily spending limit, etc) the number of winnable impressions per month can be forecasted. Still further, various statistics, for example statistics captured by any/all servers, might be used to represent a statistically reliable number of clicks per impression (e.g. clickrate).

As described above, an advertiser might select a particular campaign pricing model, and a campaign performance model, and might provide any one or more of a variety of variables attendant to such a particular campaign pricing model and/or campaign performance model.

FIG. 1G shows a screen device for ongoing campaign management using a dashboard 1G00 showing settings and statistics for an advertising campaign, according to an exemplary embodiment. As shown, one or more fields within dashboard 1G00 might be displayed to a user via a text field or other screen device. The fields might be populated either fully automatically, or in a computer-aided manner by the additional content server 108, and might be used in further calculations, and possibly without ever being presented to the user. In some embodiments, a graphical screen device 1G10 might be included in the dashboard 1G00 for reporting to a user. The entire dashboard 1G00 and any content might be generated automatically, and in some cases, merely on the basis of a minimal set of information provided by the prospective advertiser.

The dashboard 1G00 might include screen devices (e.g. knobs, sliders, pull-downs, etc) for displaying and setting campaign parameters related to a campaign pricing model (e.g. using campaign pricing model knob 1G40) or for displaying and setting parameters related to a campaign performance model (e.g. using campaign performance model knob 1G50). A campaign parameter (e.g. a business or performance metric) can be a quantity expressed as a unitless number (e.g. return on investment, number of impressions seen by a specific target audience, percent of spend to date, etc), or a business or performance metric can be a quantity expressed in specific units (e.g. cost in dollars, value in dollars, dollars per day, etc).

### Section III: Systems and Methods of Exemplary Embodiments

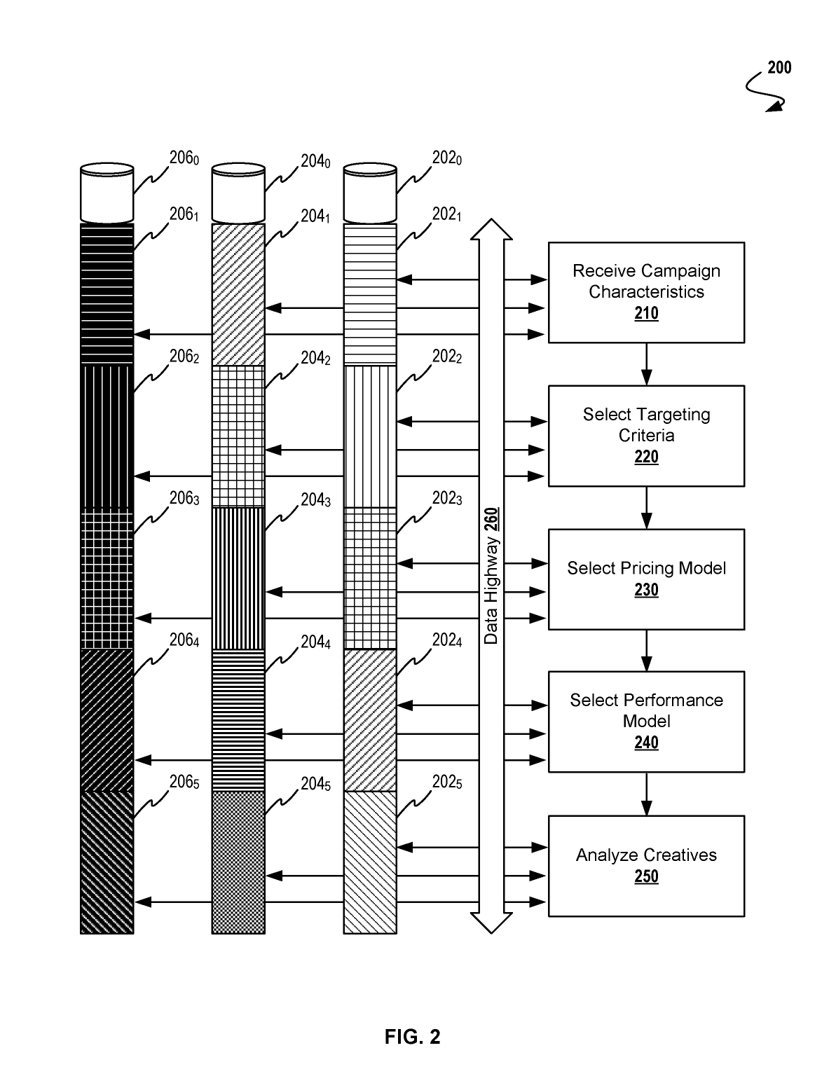

FIG. 2 is a flowchart of a method for establishing business metrics within a system for forecasting ad traffic based on business metrics in performance-based display advertising. The method 200 implements some of the steps for creating a campaign, according to one embodiment. As shown, the method 200 begins at step 210 by receiving a set of campaign characteristics (e.g. geographic location, keywords, bid phrases, creative advertising copy, creative advertising graphics, etc). In one embodiment, step 210 receives a set of campaign characteristics that results from user interaction with screen devices 1E00, 1F00, and 1G00. In another embodiment, one or more of the received characteristics might have been entered manually by a prospective advertiser using any of the screen devices discussed above, or one or more of the received characteristics might have been automatically calculated using any of the techniques herein.

Step 220 might then analyze any or all campaign-related materials, including any of the aforementioned targeting characteristics (see screen device 1F00), and select or confirm targeting criteria.

In some exemplary cases, at step 230, selection of a campaign pricing model might include user selection of a campaign pricing model such as is described in Table 1.

Continuing the description of method 200, at step 240, selection of a campaign performance model might include user selection of a campaign performance model such as is described in Table 2. Some ad campaigns may specify more than one campaign performance model, resulting in more than one performance goal. In such cases, an aggregate performance goal is used, wherein the aggregate performance goal would be the sum of the contributions from all numeric values for performance goals.

In some embodiments, a performance goal may be expressed as a minimization function (e.g. minimize cost-per-click as shown in Table 2). It is also possible that a performance goal is expressed as a numeric amount (e.g. the goal is to win impressions while bidding $0). Note that a CPA/CPC performance goal with a goal amount of $0 is generally a tracking goal, and its value is measured differently.

In some campaigns, an ad campaign could specify multiple creatives intended to be selected to participate in an auction. Accordingly, and as depicted in method 200, step 250, multiple advertisements (i.e. creatives) within a campaign are analyzed. In one embodiment (e.g. using campaign pricing models CPA and CPC), the creative with highest cost and non negative ROI is selected. For other campaign pricing models, the creative with highest estimated clicks per impression (ECPM) is selected. In other situations, a single creative from multiple creatives is selected randomly. In some situations, the results of the analysis of step 250 are saved to a dataset (e.g. dataset 202). In other situations, the results of the analysis of step 250 are passed (e.g. using a message) to another system component or method.

Again referring to FIG. 2, any of the steps 210-250 might start at any point in time, and any given step 210-250 might retrieve information from one or more databases 202₀, 204₀, 206₀, etc, at any point in time over data highway 260. Of course the data highway 260 is a notional abstraction. Examples of techniques used for communication (e.g. using a data highway 260) between any of the parallel steps 210-250 include inter-process messaging, TCP/IP or other internet communication protocol (e.g. over network 130), or even possibly including any generation of web services. Moreover, the data within any database 202₀, 204₀, 206₀ might at any point in time be stored in one or more representations, and be physically located in whole or in part in any number of locations, and made accessible to steps 210-250. Thus the steps 210-250 might each operate asynchronously, and might even each be executed on different servers, or possibly using different servers even within any one of steps 210-250.

### Embodiments of Networked Systems for Sponsored Search Advertising

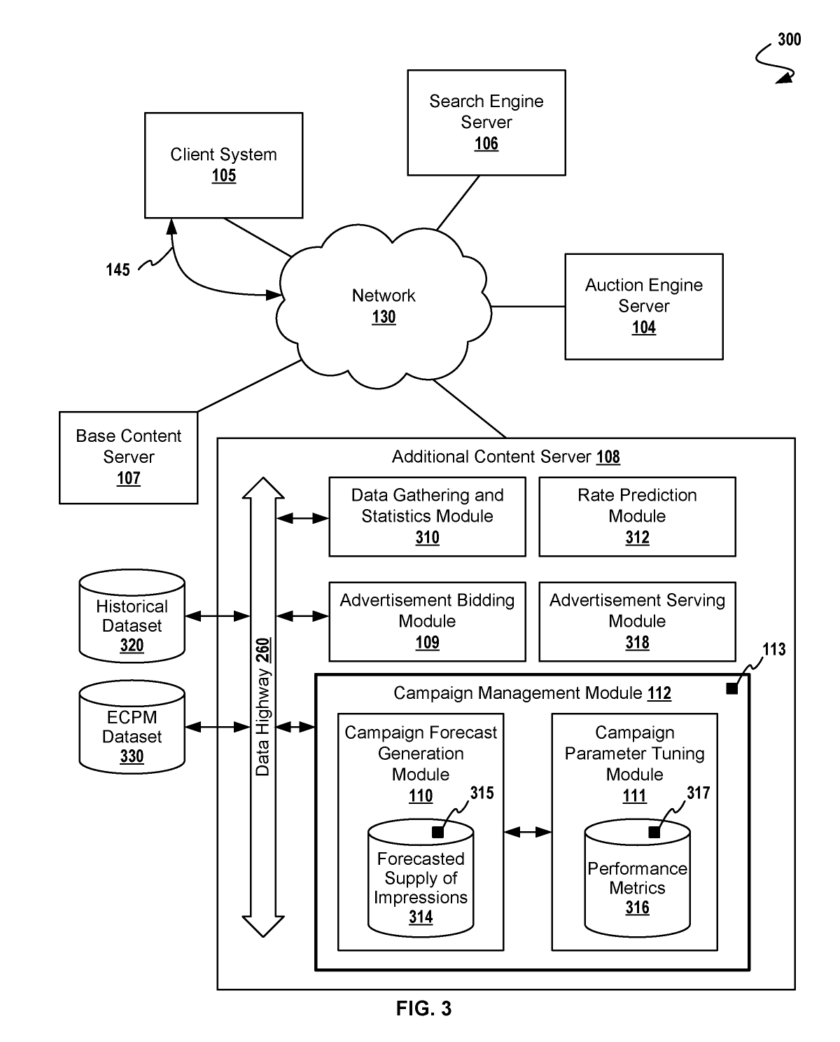

FIG. 3 shows an ad network environment including a campaign management module 112 in which some embodiments operate. In the context of internet advertising, placement of advertisements within a search results page (e.g. using an online advertising system 300 of FIG. 3) has become common. An internet advertiser or agent may select a particular property (e.g. Yahoo.com, www.disney.com, etc), and may create an advertisement such that whenever any internet user, via a client system 105, renders a web page from the selected property, the advertisement (e.g. a creative) is composited on the web page by one or more servers (e.g. a base content server 107, and/or an additional content server 108) for delivery to a client system 105 over a network 130. Given this generalized delivery model, and using techniques disclosed herein, internet advertising might be practiced, and ad traffic 145 can occur between a client system 105 and any other server over a network 130.

Again referring to FIG. 3, an internet property (e.g. a publisher hosting the publisher's base content on a base content server 107) might be able to display an advertisement (e.g. aided by an advertisement serving module 318), and then measure the characteristics of visitors (which visitors may have any arbitrary interest, demographic, target predicates, or other attributes) possibly using an additional content server 108 in conjunction with a data gathering and statistics module 310, and possibly also using a historical dataset 320 as pertains to observed users. Thus, an internet user's interests, demographics, target predicates, and/or other attributes might be known in quite some detail, and a data gathering and statistics module 310, possibly in combination with a campaign forecast generation module 110 can forecast a future supply of impressions 314. More specifically, a user's clicks (e.g. the likelihood of a click on an ad, or likelihood of a user action based on an ad) or other responses to an internet advertisement might also be known in quite some detail, not only for a particular user, but also for a group of users corresponding to a particular subset of the available data, and a campaign forecast generation module 110 can use such a particular subset of the available data for forecasting a future supply of impressions 314 where the forecast of a future supply of impressions is organized into groups, the members of the groups being impressions satisfying a particular target predicate. For example, a future supply of impressions may be organized into groups corresponding to a demographic of interest to an advertiser (e.g. “(GENDER=male && AGE=21)”). By definition, a future supply of impressions 314 may comprise one or more instances of a forecasted impression 315.

A campaign parameter tuning module 111 can use any such available data for operations for campaign parameter tuning A campaign parameter may include performance metrics 316. By definition, performance metrics 316 may comprise one or more instances of a performance metric 317.

Occurrences of user clicks can be used in statistical modeling. That is, a given model can predict the likelihood p of a click c based on an advertisement (or based on specific chartacteristrics of an advertisement), and thus, a given model can be used to calculate probability p(c|x), that quantity being the probability of a user click response based on the constituents of x. Further, such probabilities can be calculated at any point in time and selectively stored. For example, a numeric value of estimated clicks per impression (ECPM) can be stored in a dataset (e.g. in an ECPM dataset 330).

Using the techniques disclosed herein, such datasets (e.g. historical dataset 320 and/or ECPM dataset 330) can be used in the statistical modeling of ad traffic and events. Further, datasets (e.g. historical dataset 320 and/or ECPM dataset 330) can be read/written in an online mode or in an offline mode, or both. As shown, and without regard to allocation of any particular operation to any particular mode, an auction engine server 104, a base content server 107, and an additional content server 108 can operate cooperatively to implement techniques for campaign management, including techniques for forecasting ad traffic based on business metrics in performance-based display advertising.

More particularly, the embodiments described above in conjunction with the embodiments and techniques described below present a generalized framework for forecasting ad traffic based on the targeting attributes specified by advertisers, based on the inventory supply, and based on likelihood of winning an auction of an impression).

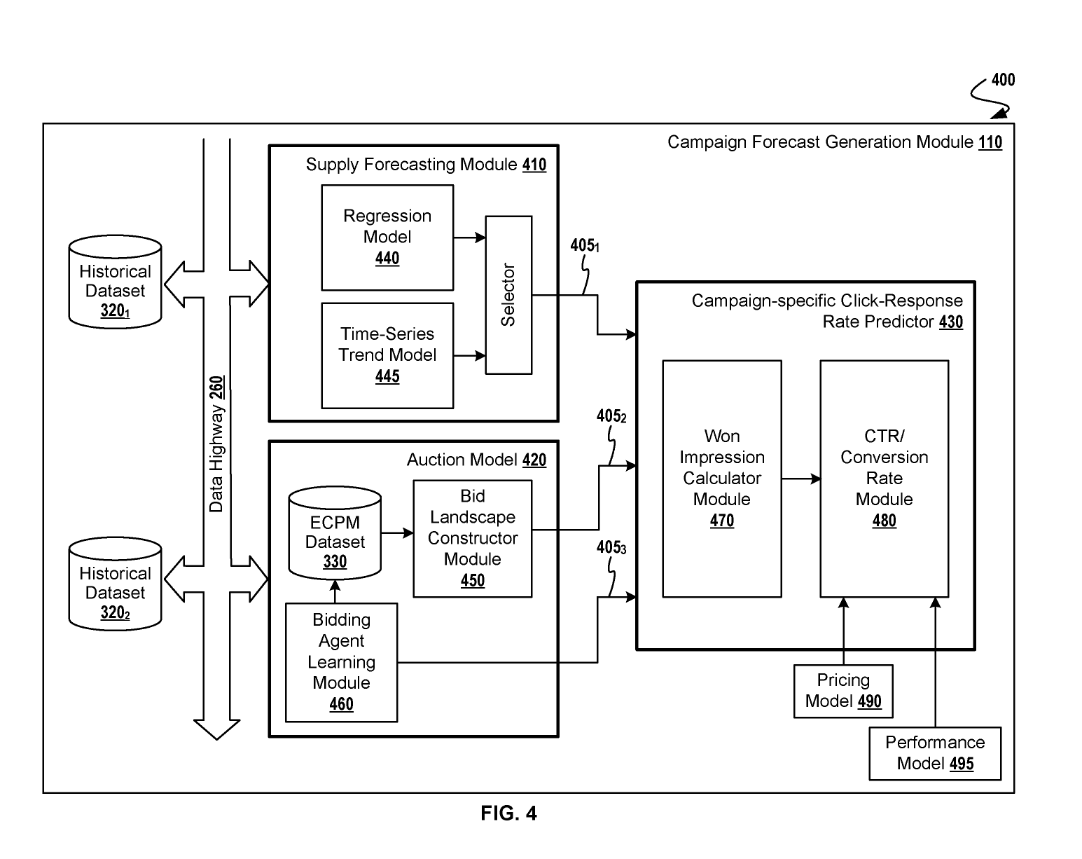

FIG. 4 is a data flow diagram of a system for forecasting ad traffic based on business metrics in performance-based display advertising. As an option, the present system 400 may be implemented in the context of the architecture and functionality of FIG. 1A through FIG. 3. In particular, system 400 might be included in embodiments of a campaign management module 112. Of course, however, the system 400 or any operation therein may be carried out in any desired environment. As shown, the system 400 is organized into modules, which modules serve for forecasting ad traffic based on business metrics in performance-based display advertising. Specifically, three modules, namely a supply forecasting module 410, an auction model 420, and a campaign-specific click-response rate predictor 430 operate in parallel, and can retrieve (or store) data over data highway 260. For example, an auction model 420 can retrieve data produced by auction engine server 104 over data highway 260 and/or via a network 130. Similarly, a click history, or conversion history, or other historical data can be retrieved from any data producer (e.g. a data gathering and statistics module 310) over data highway 260 and/or via a network 130.

A supply forecasting module 410 serves to build a supply forecasting model to forecast the overall ad-serving (impression) opportunity volume available to deliver to the advertiser's campaign, given the campaign constraints (e.g. targeting attributes specified by the advertisers), and prediction of future supply based on the aforementioned targeting attributes. An auction model 420 serves for modeling the bid landscape based on the volume of corresponding bids (e.g. derived from historical events) and a probabilistic approximation of the dynamics of the online auction process. For example, an auction model serves for predicting at least the highest bid and second highest bid for a particular forecasted impression. A bidding agent learning module 460 calculates bids, the amount of the bids depending on the aforementioned campaign parameters. In some cases, a bid price for entering in the auction process (e.g. via an advertisement bidding module 109) is determined in part by a click through rate or a conversation rate. In some embodiments, a rate prediction model (e.g. a bidding agent learning module 460) is trained for determining a bid price. For example a bidding agent learning module can includes a training model, the training model for learning a distribution of winning bids based on historical events. A campaign-specific click-response rate predictor 430 is used for predicting the volume of won impressions based on the forecasted supply (see supply forecasting module 410), and based on the bid landscape (see bid landscape constructor module 450).

The campaign-specific click-response rate predictor 430 includes a won impression calculator module 470, which module predicts the likelihood of winning in a corresponding auction based on a historical dataset (not shown). As is understood by one skilled in the art, the denominator of a click-through rate (CTR) or a conversion rate is measured in units of impressions. For predicting at the level of specificity of an advertising campaign, only won impressions (or more precisely, impressions forecasted to be won) are considered in calculating the rates of CTR/conversion rate module 480. The CTR/conversion rate module 480 provides various rate predictions such as click-through rate or conversation rate. Depending on the campaign pricing model 490 and the campaign performance model 495 of an ad campaign, a bid price for entering into the auction process is determined in part by a click through rate or a conversation rate.

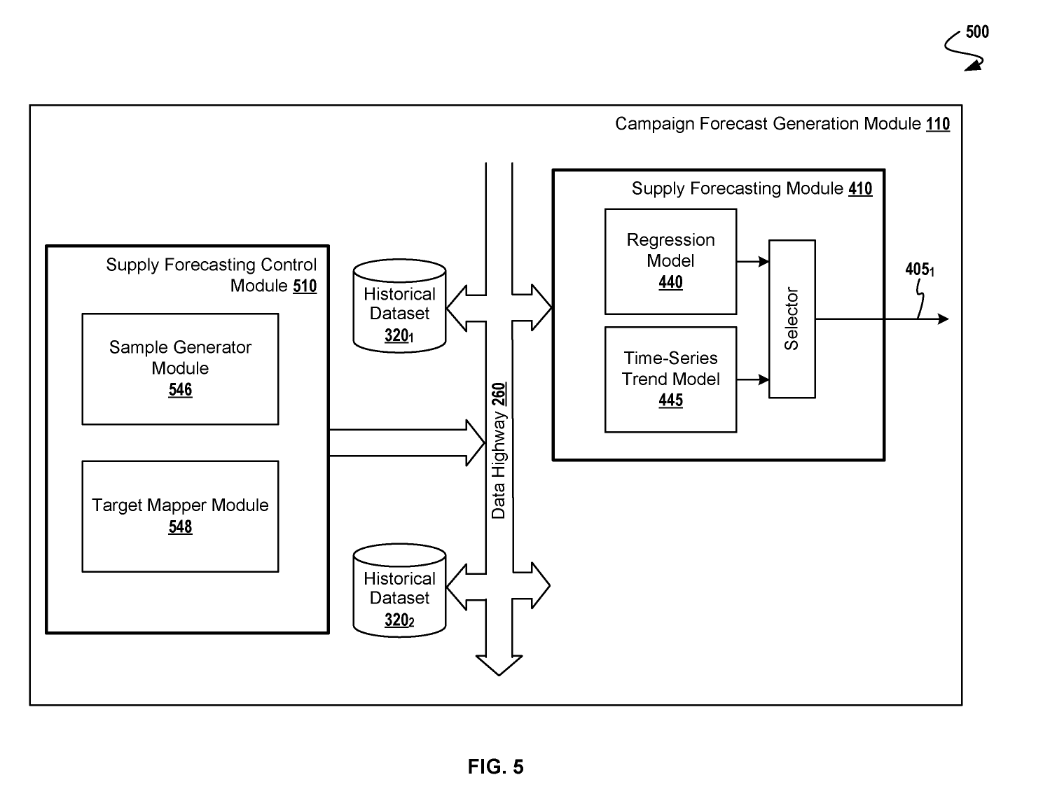

FIG. 5 is a data flow diagram of a system for supply forecasting based on business metrics in performance-based display advertising. As an option, the present system 500 may be implemented in the context of the architecture and functionality of FIG. 1A through FIG. 4. In particular, system 500 might be included in embodiments of a campaign management module 112. Of course, however, the system 500 or any operation therein may be carried out in any desired environment. As shown, the system 500 implements inventory supply forecasting using a supply forecasting module 410 and a supply forecasting control module 510. Specifically, for controlling the supply forecasting module 410, a supply forecasting control module 510 might contain a sample generator module 546 and/or a target mapper module 548.

In the embodiment of the supply forecasting module 410 as shown, two different models operate in parallel, namely 1) a generic regression model 440 that is trained on the attributes of historical events for predicting the supply volume for an ad campaign given its targeting attributes, and 2) a time-series trend model 445 for forecasting based on a historical dataset (e.g. historical data from a guaranteed delivery marketplace time-series).

In the case of a generic regression model 440, the model samples a historical dataset based on the advertiser's targeting attributes. It should be noted that the targeting attributes specified by an advertiser might not be as specific as the targeting attributes recorded in the historical dataset. For example, an advertiser might target users “between 20 years old and 25 years old”. However, the historical dataset might be codified more granularly (e.g. with historical data corresponding to a user of age 21, a different user of age 22, etc. Thus, some embodiments synthesize samples based on an advertiser's targeting attributes, produce a supply forecast for each synthesized sample, and aggregate the results to produce a supply forecast for the ad campaign according to the advertiser's targeting attributes in the campaign. For this purpose, a supply forecasting control module 510 might contain a target mapper module 548.

In the case of a time-series trend model 445, the model samples a sufficient number of samples (e.g. based on a calculated sampling ratio) and then adjusts the forecastable volume based on the sampling ratio. For this purpose, a supply forecasting control module 510 might contain a sample generator module 546.

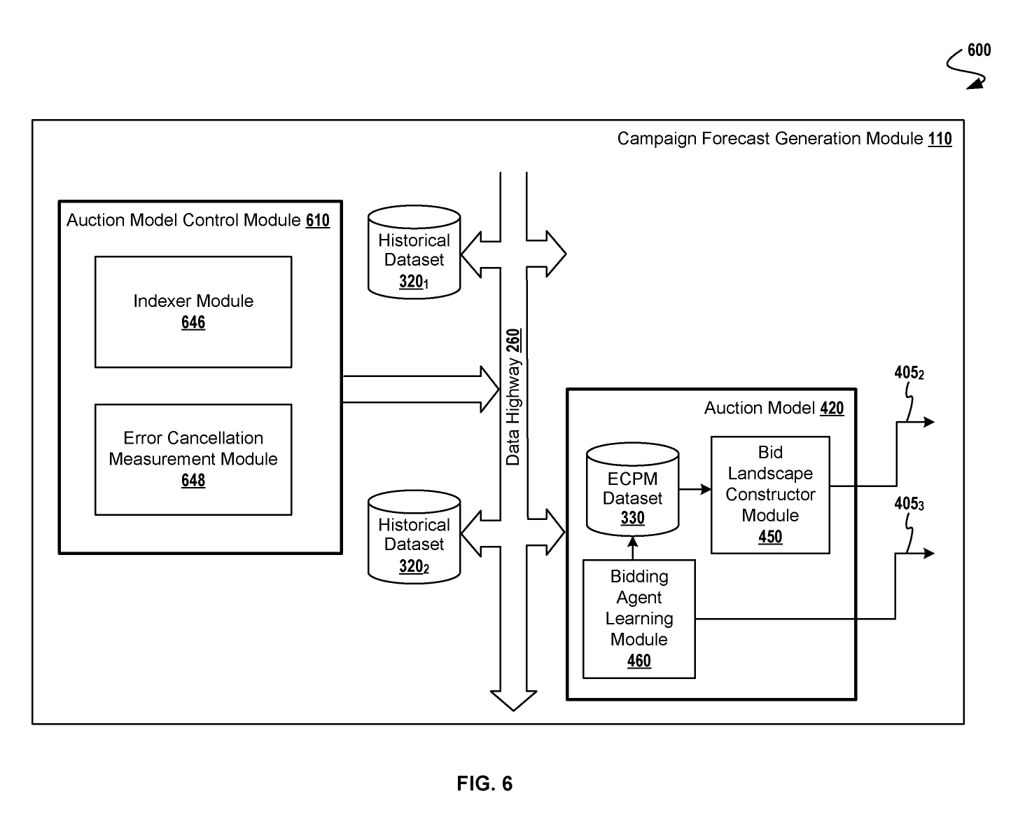

FIG. 6 is a data flow diagram of a system for modeling an advertisement auction based on business metrics in performance-based display advertising. As an option, the present system 600 may be implemented in the context of the architecture and functionality of FIG. 1A through FIG. 5. In particular, system 600 might be included in embodiments of a campaign management module 112. Of course, however, the system 600 or any operation therein may be carried out in any desired environment. As shown, the auction model 420 determines the likelihood of winning a bid based on a calculated bid price within a calculated bid landscape. For controlling the auction model 420, a auction model control module 610 might contain an indexer module 646 and/or a error cancellation measurement module 648.

As shown, a bid landscape is constructed for the bid volume from historical events using a historical dataset 320. For example, a bid landscape can be constructed as a distribution graph (or table) setting forth a likelihood of winning an auction based on a particular bid price for a particular impression. For controlling the auction model 420, a auction model control module 610 might contain an indexer module 646 for aiding in modeling the dynamics (e.g. number of possible bidders) of the spot marketplace abstraction.

The aforementioned abstraction provides an approximation of the dynamics of a real-time auction process in an online exchange. Although such an approach abstracts to a level above the detailed bidding dynamics, this approach enables processing huge web-scale data in a very efficient way, and provides error cancelling effects. One embodiment learns a distribution for the winning bid based on historical events satisfying the targeting attributes of the ad campaign. In this embodiment, the bid landscape constructor module 450 calculates how frequently an advertiser's bid (e.g. based on, or selected from, an ad campaign) will win the bid-on impression, given the landscape of bids. Using a bidding agent learning module 460, such distribution can be learned in a parametric way (normal, log-normal, etc) or non-parametrically. For controlling the auction model 420, a auction model control module 610 might contain an error cancellation measurement module 648 for aiding in measuring the dynamics in the abstration (e.g. extent of cancellation effects) of the spot marketplace abstraction.

Section IV: Integration with Pricing and Performance Models

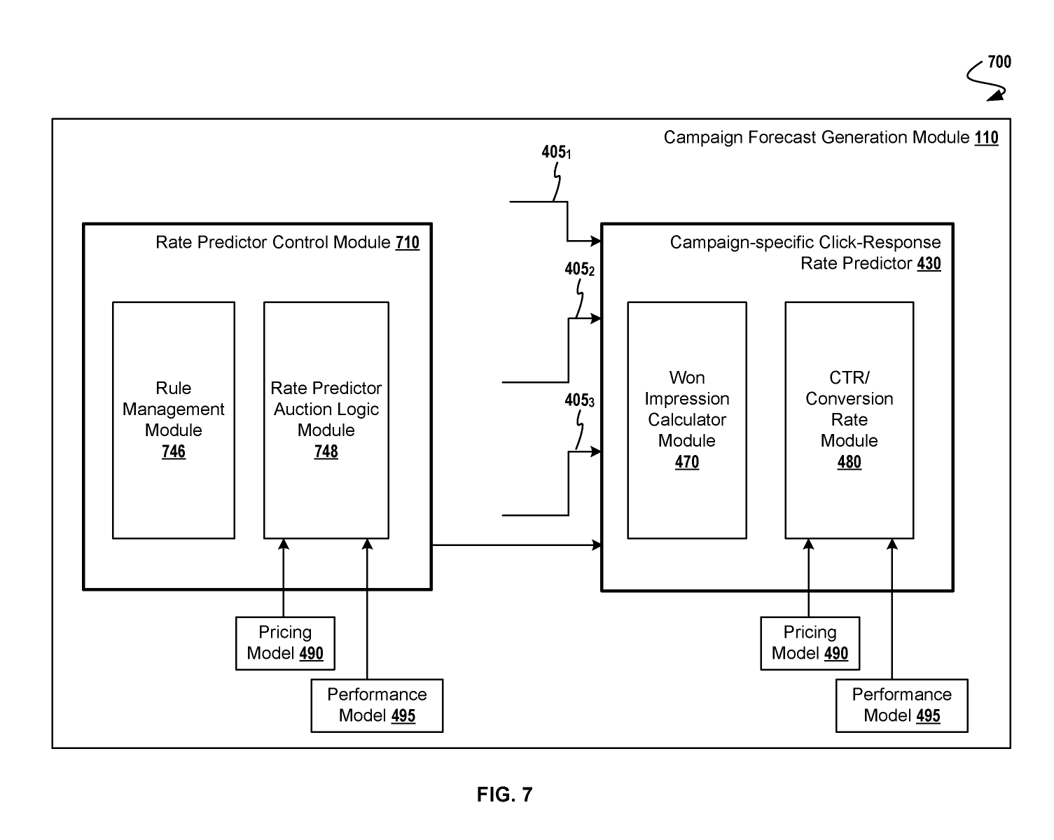

FIG. 7 is a data flow diagram of a system for campaign-specific click-response rate predictor based on business metrics in performance-based display advertising. As an option, the present system 700 may be implemented in the context of the architecture and functionality of FIG. 1A through FIG. 6. In particular, system 700 might be included in embodiments of a campaign management module 112. Of course, however, the system 700 or any operation therein may be carried out in any desired environment. As shown, the campaign-specific click-response rate predictor 430 determines the likelihood of a click or conversion based on available supply (e.g. see path 405₁), and a calculated bid price (see path 405₃) within a calculated bid landscape (see path 405₂). The campaign-specific click-response rate predictor 430 includes a won impression calculator module 470, which module predicts the likelihood of winning in a corresponding auction based on a historical dataset. For example, an auction model 420 might process all or part of a historical dataset 320₃ (not shown) in order to create a chart or a mathematical function or table used to implement a mathematical function, such as Table 3.

TABLE 3

| Estimated Cost per | # of Won | |
|---|---|---|
| Impression | Impressions | Comment |
| 0 | 0 | |
| 1 | 20 | |
| 2 | 35 | Steep rise |
| 3 | 40 | Flattens |
| 4 | 40 | Remains flat |

As is understood by one skilled in the art, the denominator of a click-through rate (CTR) or a conversion rate is measured in units of impressions. For predicting at the level of specificity of an advertising campaign, only won impressions (or more precisely, impressions forecasted to be won) are considered in calculating the rates of CTR/conversion rate module 480. The CTR/conversion rate module 480 provides various rate predictions such as click-through rate or conversation rate. Depending on the campaign pricing model 490 and the campaign performance model 495 of an ad campaign, a bid price for entering into the auction process is determined in part by a click-through rate or a conversation rate. For example, for a campaign having a CPM campaign pricing model and a CPA campaign performance model, it enters into the auction process only when an expected CPM (ECPM) is larger than the CPM price, where ECPM is a product of a conversion rate and a CPA goal price.

Returning to the discussion of FIG. 6, the auction model 420 serves to orient the predictions for input to a campaign-specific click-response rate predictor 430. As shown, the campaign-specific click-response rate predictor 430 predicts a click-response for a given campaign. For controlling the campaign-specific click-response rate predictor 430, a rate predictor control module 710 might contain a rule management module 746 and/or a rate predictor auction logic module 748.

As can now be understood, the results of a campaign-specific click-response rate predictor 430 depend (at least in part) on the campaign pricing models and campaign performance models as specified in the campaign. For example, given the supply forecasting results, the auction model 420 serves to calculate bid price and bid eligibility (possibly using a rate predictor auction logic module 748) for the campaign pricing model and campaign performance model combination. This calculated bid is used to calculate probability of winning the auction within the corresponding bid landscape. Once the number of won impressions is calculated, a CTR/conversion rate module 480 can forecast clicks and conversions.

### Campaign Pricing Model Enumeration

Disclosed herein are six different campaign pricing models:

Cost-per-thousand impressions (CPM)

Dynamic CPM (dCPM)

Cost-per-click (CPC)

Cost-per-action (CPA)

dCPM_SpendMax

dCPM_WinAtAllCost

Also, disclosed herein are three different campaign performance models:

CPC campaign performance model

CPA campaign performance model

Bid-based campaign performance model

For purposes of rigorous analysis of rules, define:

cost=investment (e.g. in currency) associated with a campaign pricing model

value=return (e.g. in currency) associated with a campaign performance model

Return-On-Investment (ROI)=value−cost

Now, a subset of the possible combination scenarios and corresponding rules are:

TABLE 4

| Scenario | Bidding Participation Rule |
|---|---|
| Bid-based campaign | Bid up to Max Bid Amount |
| Performance Model | |
| Other than Bid-based campaign | Bids if and only if ROI >= 0 |
| Performance Model | |
| Multiple Creatives | Select only one creative for bid |
| Multiple Performance Goals in a | Sum contribution from individual goals |
| Campaign | |
| Multiple Performance Goals in a | Average contribution from |
| Creative | individual goals |

An ad campaign might have multiple creatives, however in embodiments following the above bidding participation rules, only one creative is chosen to participate in the auction. For campaign pricing models CPA and CPC, the bidding participation rule (possibly implemented using a rule management module 746) chooses the creative with the highest cost and non-negative ROI. For other campaign pricing models, if needed, the creative with highest ECPM, if applicable, is chosen; otherwise a creative is picked at random.

An ad campaign might have multiple goals. When calculating value, the contribution from all goals is summed.

When clicks and conversions are forecasted, multiple goals (e.g. multiple performance goals) could potentially exist, each goal associated with a selected creative (thus multiple goal probabilities). In some cases, the average of all goal probabilities associated with this creative can be used. Following the rules of Table 4, the cost calculations and bidding logic is detailed below.
1. CPA pricing with Bid goal: cost=CPA*Prob(conv). Bid cost.
2. CPC pricing with Bid goal: cost=CPC*Prob(click). Bid cost.
3. CPC pricing with CPA goal: cost=CPC*Prob(click) and value=CPA*Prob(conv). If ROI>0, bid cost, otherwise do not bid.
4. CPM pricing with Bid goal: Bid CPM.
5. CPM pricing with CPA goal: cost=CPM and value=CPA*Prob(conv). If ROI>0, bid cost, otherwise do not bid.
6. CPM pricing with CPC goal: cost=CPM and value=CPC*Prob(click). If ROI>0, bid cost, otherwise do not bid.
7. dCPM_WinAtAllCost pricing with CPA goal: Bid dCPM_WinAtAllCost (same as CPM with Bid goal).
8. dCPM_WinAtAllCost pricing with CPC goal: Bid dCPM_WinAtAllCost (same as CPM with Bid goal).
9. dCPM pricing with CPA goal:
   a) Accumlated_Bids=0; Won_Imps=0;
   b) Go through each sample:
      value=CPA*Prob(conv);
      Remaining Balance=Won_Imps*dCPM-Accumlated_Bids;
      Bid Actual_Cost=min(value, dCPM+Remaining Balance, 2*dCPM);
      Add the forecasted won impressions from this sample to Won_Imps;
      Update Accumlated_Bids with Actual_Cost;
10. dCPM pricing with CPC goal:
   a) Accumlated_Bids=0; Won_Imps=0;
   b) Go through each sample:
      value=CPC*Prob(click);
      Remaining Balance=Won_Imps*dCPM-Accumlated_Bids;
      Bid Actual_Cost=min(value, dCPM+Remaining Balance, 2*dCPM);
      Add the forecasted won impressions from this sample to Won_Imps;
      Update Accumlated_Bids with Actual_Cost;

One possible display of the results of execution through the system 700 of FIG. 7 could be a tabularlized display such as Table 5.

TABLE 5
Advertiser: Acme Corp (1234)
Line Item: Retargeting Campaign (12345)

| Price | Forecast | | | |
|---|---|---|---|---|
| CPA | Conv/Day | Conv/Mo | Impressions/Mo | Spend/Mo |
| $10.00 | 5 | 150 | 962,336 | $1,500 |
| $12.50 | 10 | 300 | 1,924,671 | $3,750 |
| $15.00 | 22 | 660 | 4,234,276 | $9,900 |
| $17.50 | 32 | 960 | 6,158,947 | $16,800 |
| $20.00 | 52 | 1,560 | 10,008,289 | $31,200 |
| $22.50 | 85 | 2,550 | 16,359,704 | $57,375 |
| $25.00 | 92 | 2,760 | 17,706,973 | $69,000 |

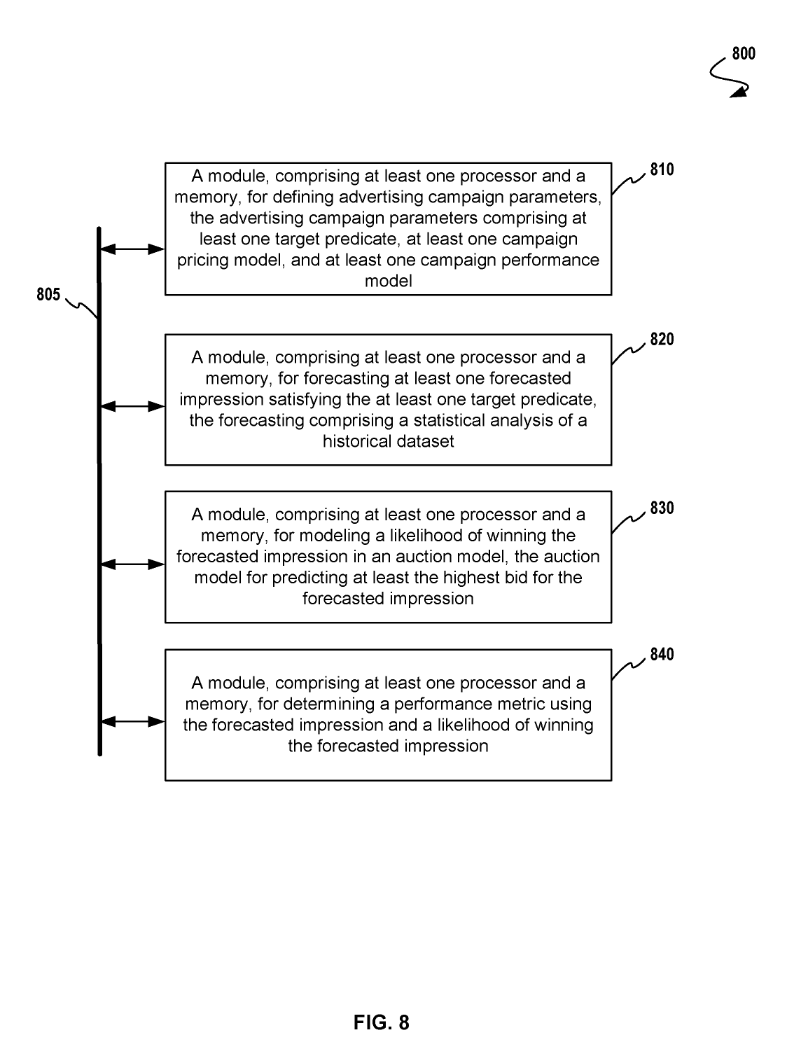

FIG. 8 depicts a block diagram of a system to perform certain functions of an advertising server network. As an option, the present system 800 may be implemented in the context of the architecture and functionality of the embodiments described herein. Of course, however, the system 800 or any operation therein may be carried out in any desired environment. As shown, system 800 comprises a plurality of modules, a module comprising at least one processor and a memory, each module connected to a communication link 805, and any module can communicate with other modules over communication link 805. The modules of the system can, individually or in combination, perform method steps within system 800. Any method steps performed within system 800 may be performed in any order unless as may be specified in the claims. As shown, FIG. 8 implements an advertising server network as a system 800, partitioned into modules, a module comprising at least one processor and a memory, and including modules for defining advertising campaign parameters, the advertising campaign parameters comprising at least one target predicate, at least one campaign pricing model, and at least one campaign performance model (see module 810) and a module for forecasting at least one forecasted impression satisfying the at least one target predicate, the forecasting comprising a statistical analysis of a historical dataset (see module 820); a module for modeling a likelihood of winning the forecasted impression in an auction model, the auction model for predicting at least the highest bid for the forecasted impression (see module 830); and a module for determining a performance metric using the forecasted impression and a likelihood of winning the forecasted impression (see module 840).

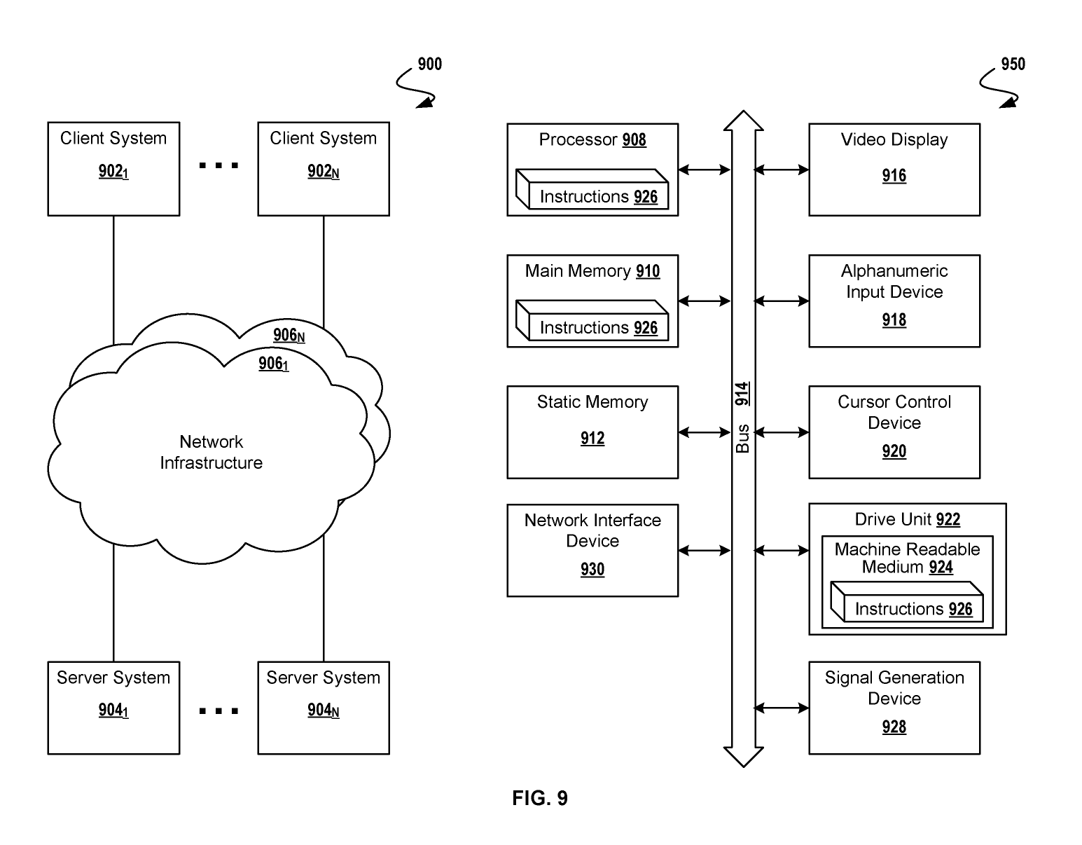

FIG. 9 is a diagrammatic representation of a network 900, including nodes for client computer systems 902₁ through 902_{N}, nodes for server computer systems 904₁ through 904_{N}, and nodes for network infrastructure 906₁ through 906_{N}, any of which nodes may comprise a machine (e.g. computer 950) within which a set of instructions for causing the machine to perform any one of the techniques discussed above may be executed. The embodiment shown is purely exemplary, and might be implemented in the context of one or more of the figures herein.

Any node of the network 900 may comprise a general-purpose processor, a digital signal processor (DSP), an application specific integrated circuit (ASIC), a field programmable gate array (FPGA) or other programmable logic device, a discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems (including a processor and memory), a massively parallel computer system, and/or a cloud computer system.

The computer system (e.g. computer 950) includes a processor 908 (e.g. a processor core, a microprocessor, a computing device, etc), a main memory (e.g. computer memory 910), and a static memory 912, which communicate with each other via a bus 914. The computer 950 may further include a display unit (e.g. computer display 916) that may comprise a touch-screen, or a liquid crystal display (LCD), or a light emitting diode (LED) display, or a cathode ray tube (CRT). As shown, the computer system also includes a human input/output (I/O) device 918 (e.g. a keyboard, an alphanumeric keypad, etc), a pointing device 920 (e.g. a mouse, a touch screen, etc), a drive unit 922 (e.g. a disk drive unit, a CD/DVD drive, a tangible computer readable removable media drive, an SSD storage device, etc), a signal generation device 928 (e.g. a speaker, an audio output, etc), and a network interface device 930 (e.g. an Ethernet interface, a wired network interface, a wireless network interface, a propagated signal interface, etc). The drive unit 922 includes a machine-readable medium 924 on which is stored a set of instructions (i.e. software, firmware, middleware, etc) 926 embodying any one, or all, of the methodologies described above. The set of instructions 926 is also shown to reside, completely or at least partially, within the main memory and/or within the processor 908. The set of instructions 926 may further be transmitted or received via the network interface device 930 over the network bus 914.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing non-transitory information in a form readable by a machine (e.g. a computer). For example, a machine-readable medium includes read-only memory (ROM); random access memory (RAM); magnetic disk storage media; optical storage media; flash memory devices; and electrical, optical or acoustical or any other type of media suitable for storing non-transitory information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for forecasting ad traffic based on business metrics in performance-based display advertising, the method comprising:
defining, in memory, advertising campaign parameters, the advertising campaign parameters comprising at least one target predicate, at least one campaign pricing model, and at least one campaign performance model;
forecasting, using a computer, at least one forecasted impression satisfying the at least one target predicate, the forecasting comprising a statistical analysis of a historical dataset;
modeling, using a computer, a likelihood of winning the forecasted impression in an auction model, the auction model for predicting at least the highest bid for the forecasted impression; and
determining, using a computer, a performance metric using the forecasted impression and a likelihood of winning the forecasted impression.

2. The method of claim 1, further comprising:
reporting, using a display device, the performance metric.

3. The method of claim 1, wherein the defining advertising campaign parameters comprises user input of at least one campaign parameter using a screen device.

4. The method of claim 1, wherein the modeling includes a bidding agent training model, the training model for learning a distribution of winning bids based on historical events.

5. The method of claim 1, wherein the performance metric is one of, a click-through-rate, a click-response rate, a number of won impressions.

6. The method of claim 1, wherein the campaign pricing model is at least one of, cost-per-impression, cost-per-click, cost-per-action.

7. The method of claim 1, wherein the campaign performance model is at least one of, a minimize cost-per-click model, a minimize cost-per-action model.

8. An advertising server network forecasting ad traffic based on business metrics in performance-based display advertising, comprising:
a module, comprising at least one processor and memory, for defining advertising campaign parameters, the advertising campaign parameters comprising at least one target predicate, at least one campaign pricing model, and at least one campaign performance model;
a module, comprising at least one processor and memory, for forecasting at least one forecasted impression satisfying the at least one target predicate, the forecasting comprising a statistical analysis of a historical dataset;
a module, comprising at least one processor and memory, for modeling a likelihood of winning the forecasted impression in an auction model, the auction model for predicting at least the highest bid for the forecasted impression; and
a module, comprising at least one processor and memory, for determining a performance metric using the forecasted impression and a likelihood of winning the forecasted impression.

9. The advertising server network of claim 8, further comprising:
reporting, using a display device, the performance metric.

10. The advertising server network of claim 8, wherein the defining advertising campaign parameters comprises user input of at least one campaign parameter using a screen device.

11. The advertising server network of claim 8, wherein the modeling includes a bidding agent training model, the training model for learning a distribution of winning bids based on historical events.

12. The advertising server network of claim 8, wherein the performance metric is one of, a click-through-rate, a click-response rate, a number of won impressions.

13. The advertising server network of claim 8, wherein the campaign pricing model is at least one of, cost-per-impression, cost-per-click, cost-per-action.

14. The advertising server network of claim 8, wherein the campaign performance model is at least one of, a minimize cost-per-click model, a minimize cost-per-action model.

15. A computer readable medium comprising a set of instructions which, when executed by a computer, cause forecasting of ad traffic based on business metrics in performance-based display advertising, said instructions for:
defining, in memory, advertising campaign parameters, the advertising campaign parameters comprising at least one target predicate, at least one campaign pricing model, and at least one campaign performance model;
forecasting, using a computer, at least one forecasted impression satisfying the at least one target predicate, the forecasting comprising a statistical analysis of a historical dataset;
modeling, using a computer, a likelihood of winning the forecasted impression in an auction model, the auction model for predicting at least the highest bid for the forecasted impression; and
determining, using a computer, a performance metric using the forecasted impression and a likelihood of winning the forecasted impression.

16. The computer readable medium of claim 15, wherein the defining advertising campaign parameters comprises user input of at least one campaign parameter using a screen device.

17. The computer readable medium of claim 15, wherein the modeling includes a bidding agent training model, the training model for learning a distribution of winning bids based on historical events.

18. The computer readable medium of claim 15, wherein the performance metric is one of, a click-through-rate, a click-response rate, a number of won impressions.

19. The computer readable medium of claim 15, wherein the campaign pricing model is at least one of, cost-per-impression, cost-per-click, cost-per-action.

20. The computer readable medium of claim 15, wherein the campaign performance model is at least one of, a minimize cost-per-click model, a minimize cost-per-action model.
